(19) United States
(12) Patent Application Publication
(10) Pub. No.: US 2012/0160829 A1
(43) Pub. Date: Jun. 28, 2012

(54) POLYARYLENE ETHER KETONE COMPOSITION FOR INDUCTION WELDING

(75) Inventors: Nicolas Dufaure, Bernay (FR); Benoit Brule, Beaumont-Le-Roger (FR); Michel Glotin, Saint-Cloud (FR)

(73) Assignee: ARKEMA FRANCE, Colombes (FR)

(21) Appl. No.: 13/381,395

(22) PCT Filed: Jun. 29, 2010
(86) PCT No.: PCT/FR2010/051357

§ 371 Date: Mar. 13, 2012

(30) Foreign Application Priority Data
Jun. 30, 2009 (FR) 0954462

(51) Int. Cl. B23K 13/01; B32B 5/02; H01F 1/06

(52) U.S. Cl. 219/617; 252/62.54; 442/110

(57) ABSTRACT

The invention relates to a polymer composition containing at least one polyarylene ether ketone, optionally filled with fibers or other elements increasing the modulus, and with ferrimagnetic or ferromagnetic conductive particles that can be used in the manufacture of articles that can be welded by induction in an alternating electromagnetic field, together with objects manufactured with the composition of the invention. It also relates to the induction welding of these objects using an alternating electromagnetic field.

The invention relates to a polymer composition containing at least one polyarylene ether ketone, optionally filled with fibers or other elements increasing the modulus, and with ferrimagnetic or ferromagnetic conductive particles that can be used in the manufacture of articles that can be welded by induction in an alternating electromagnetic field.

The polyarylene ether ketones are polymers with very high performance, suitable for production of articles used in fields with demanding requirements, such as aeronautics and aerospace, medicine, electronics, petroleum exploration and exploitation or certain automotive applications.

In these fields, it is sometimes necessary to weld components, and among the methods used, induction welding is a method of choice. Induction welding permits high welding speeds, localization of the heating (and therefore of the welds), weld beads that are clean, small and of a constant quality. Moreover, the use of certain frequency ranges, typically around 2 MHz, provides greater safety for people working near these electromagnetic fields.

The applicant has now found that the polymer composition containing at least one polyarylene ether ketone, optionally filled with fibers or other elements increasing the modulus, with certain conductive metal powders such as iron, ferrite, magnetite or certain alloys based on metals, was advantageously usable for making high-performance components that can be welded by induction at frequencies between 50 KHz and 100 MHz and preferably between 100 KHz and 10 MHz, inclusive.

### PRIOR ART

U.S. Pat. No. 6,939,477 B2 claims a composition combining a matrix with nonconductive particles of hexagonal ferrite with a size greater than or equal to one micron and with a Curie point close to the transformation temperature of the matrix, to permit control of the temperature of said composition when it is subjected to induction heating.

Patent WO2008/110327 A1 describes a method of welding polyamide material associated with particles based on iron. Several methods of welding are described as being usable. Moreover, the polyamide can also be combined with polyether ether ketone (PEEK). In this application, the preferred method of welding is vibration or hot plate welding, which are methods that are particularly suitable for welds on small components, and moreover they limit the possibility of multiple welds on one and the same assembly of components.

Document US 2008/0292824 describes the welding of plastic composite in an alternating electromagnetic field, the weld being obtained by means of nanometric particles of magnetic oxides. The use of nanometric particles requires the availability of a suitable method for ensuring good dispersion of them, if we are to obtain a material having the best properties, notably mechanical. It is moreover recommended for very small fillers, with diameter typically less than 1 μm, to use electromagnetic fields at high frequencies, typically >100 MHz, to ensure sufficient heating of the materials. The generators capable of establishing these electromagnetic fields are generally expensive and the high frequencies are more dangerous for people close to these electromagnetic fields.

Document WO2009/002558 describes a composition of polymer and magnetic particles. This application does not specifically take into account the combination polyarylene ether ketones whether or not filled with conductive particles. When the latter are used, they are combined with nonconductive magnetic particles. Moreover, the weld is obtained in an electromagnetic field with modulated pulse width.

The applicant has now found that the use of ferromagnetic or ferrimagnetic conductive particles with average diameter greater than 1 μm and less than 1 mm in a polymer matrix containing at least one polyarylene ether ketone, optionally filled with fibers or other elements increasing the modulus, allows objects to be obtained that can be welded by induction, and thus the production of complex components with high performance, in an alternating electromagnetic field between 50 KHz and 100 MHz, and preferably between 100 KHz and 10 MHz; moreover, this frequency range offers better safety for people working near these devices.

### SUMMARY OF THE INVENTION

The invention relates to a composition combining:
at least one polyarylene ether ketone that can contain at least one reinforcing filler,
at least one ferromagnetic or ferrimagnetic conductive particle.
   The invention also relates to the use of this composition in the production of components that can be welded by an induction welding device using an alternating electromagnetic field with a frequency between 50 KHz and 100 MHz, and preferably between 100 KHz and 10 MHz.

The invention also relates to objects manufactured with the composition of the invention. It also relates to the induction welding of these objects using an alternating electromagnetic field.

For the sake of clarity in the rest of the text, the following definitions will be used:
“Polymer” denotes one or more polymers of the polyarylene ether ketone (PAEK) type.
“At least one” signifies one or more.

### DETAILED DESCRIPTION

The polyarylene ether ketones used in the invention, also called PAEKs, are polymers that have units with the following formulas:

(—Ar—X—) and (—Ar₁—Y—)

in which:

Ar and Ar₁ each denote an aromatic divalent radical; Ar and Ar₁ may be identical or different;

Ar and Ar₁ can be selected, preferably, from 1,3-phenylene, 1,4-phenylene, 4,4′-biphenylene, 1,4-bis(4-phenoxybenzoyl) phenylene, 1,4-naphthylene, 1,5-naphthylene and 2,6-naphthylene, or even anthracenylene units,

X denotes an electron-attracting group; it can preferably be selected from the carbonyl group and the sulfonyl group,

Y denotes a group selected from an oxygen atom, a sulfur atom, an alkylene group, such as —CH₂—, isopropylidene or hexafluoroisopropylidene.

In these units, at least 50%, preferably at least 70% are a carbonyl group. More particularly, at least 80% of the groups X are a carbonyl group. Moreover at least 50%, preferably at least 70% of the groups Y represent an oxygen atom. More particularly at least 80% of the groups Y represent an oxygen atom.

According to a preferred embodiment, 100% of the groups X denote a carbonyl group. According to another embodiment, 100% of the groups Y represent an oxygen atom.

More preferably, the polyarylene ether ketone (PAEK) can be selected from:
a polyether ether ketone also called PEEK, comprising units of formula I:

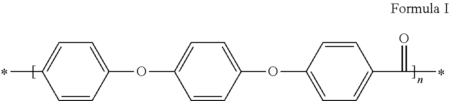

a polyether ketone also called PEK, comprising units of formula II:

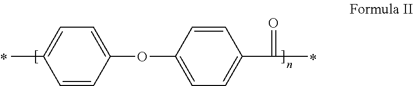

a polyether ketone ketone also called PEKK, comprising units of formula IIIA, of formula IIIB and a mixture thereof:

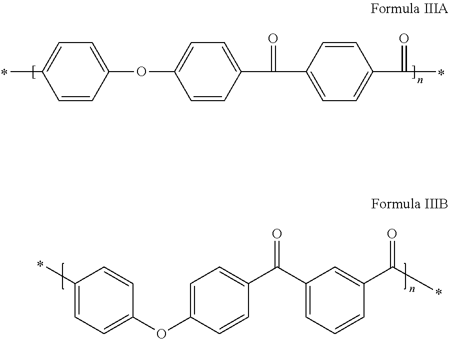

a polyether ether ketone ketone also called PEEKK, comprising units of formula IV:

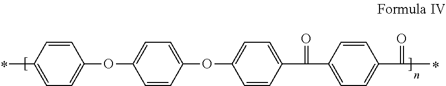

and a polyether ether ketone ketone also called PEKEKK, comprising units of formula V:

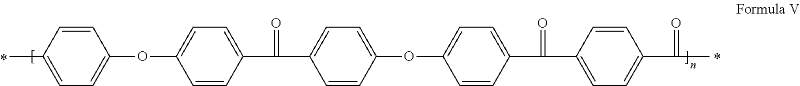

However, other arrangements of the carbonyl group and of the oxygen atom are also possible.

The polymer usable according to the invention can be semicrystalline or amorphous. It is present in proportions in the range from 1 to 99 wt. % of the composition. More particularly, it is present in proportions from 20 to 95 wt. % of the composition. Preferably, the polymer usable according to the invention is PEKK.

It is sometimes necessary to mix the polymers to optimize the properties of the materials. In the context of the invention, the polyaryl ether ketone can be blended with another polyaryl ether ketone. This is sometimes desirable for example to modify the rheology or the crystallinity. Thus, the blends PEKK-PEEK, PERK-PEK, PEKK-PEKEKK, PEKK-PEEKK, PEKK-PEKK can be considered in the context of the invention. In the last-mentioned case in particular, it will be possible to blend amorphous and crystalline PEKKs or PEKKs with different crystallinity.

According to one embodiment of the invention, the reinforcing fillers used in the context of the invention can be mineral fillers such as talc, montmorillonite, chalk, mica, kaolin.

According to another embodiment of the invention, the reinforcing fillers can be glass fibers or carbon fibers. In the last-mentioned embodiment of the invention, the fibers can be short or long, or can be in the form of a woven or nonwoven mat.

According to another embodiment of the invention, the reinforcing fillers can be carbon fillers such as expanded or unexpanded graphite, carbon black, carbon nanotubes.

The mineral fillers can be present in proportions from 5 to 30 wt %. of the composition. More particularly, the mineral fillers are present in proportions from 5 to 20 wt. % of the composition. The fibers or the mats of fibers and carbon fillers can be present in proportions from 5 to 60 wt. % of the composition. More particularly, the fibers or the mats of fibers and the carbon fillers are present in proportions from 10 to 30 wt. % of the composition.

The fillers can be surface-treated if required, to improve their adhesion to the polymer.

The ferromagnetic or ferrimagnetic conductive particles according to the invention are iron compounds, or alloys based on iron and one or more elements, selected from manganese, cobalt, magnesium, copper, nickel, oxygen (non-exhaustive list).
whose average diameter (measured using techniques such as laser diffraction, sieving, analysis of images obtained by microscopy, etc.) is from 1 μm to 1 mm, inclusive.
and whose electrical conductivity, measured according to standard ASTM D 4496, is greater than 10⁻³ S. These particles are present in proportions in the range from 5 to 80 wt. % of the composition.

Moreover, the compositions of the invention can contain conventional additives such as anti-UV additives, antioxidant additives, lubricating additives, etc.

The compositions of the invention can be obtained by mixing the polymer in the molten state, fillers, and ferromagnetic or ferrimagnetic conductive particles in a compounding device known by a person skilled in the art such as an extruder, a kneader or an internal mixer. In this case, the fillers can be introduced either in the same hopper as the polymer or in another hopper (i.e. in the molten polymer in the latter case).

According to another embodiment, the compositions of the invention can be obtained by mixing a premix of polymer and filler, and ferromagnetic or ferrimagnetic conductive particles, these two steps (preparation of the premix and production of the final formulation) being carried out in a compounding device with the polymer in the molten state known by a person skilled in the art such as an extruder, a kneader or an internal mixer.

The objects of the invention are obtained:
For compositions without reinforcing fillers or for compositions containing reinforcing fillers which are not fibers, by extrusion, injection, injection molding, etc.
For compositions with fiber fillers:
For short fibers by injection (or compression-injection) of short-fiber granules, the granules being obtained by mixing (compounding) of the compositions of the invention in an extruder (preferably twin-screw) and chopping of the rod obtained. These operations are carried out above the melting point of the polyarylene ether ketone with the highest melting point.
For long fibers by injection (or compression-injection) of long-fiber granules, the granules being obtained by impregnation of bundles of continuous fibers in the mixture of molten polymer and ferrimagnetic or ferromagnetic particles by means of an extruder with straight extrusion head and then chopping of the rod obtained. Long fibers in the form of roving can also be incorporated directly during injection.
For woven or nonwoven mats, production of stratified plates by hot pressing at temperatures above the melting point of the polyarylene ether ketone with the highest melting point, in an alternating stack of woven or nonwoven fiber mats and films of the mixture of polymer and ferrimagnetic or ferromagnetic particles or rolling of woven or nonwoven fiber mats on a film of the mixture of polymer and ferrimagnetic or ferromagnetic particles.
For bundles of fibers, or a mat of fibers (woven or nonwoven), preparation of prepregs obtained either by impregnation (cladding) of the fibers in a bath of the mixture of molten polymer and ferrimagnetic or ferromagnetic particles (in the case of bundles of fibers, with a straight-head extruder), or by impregnation in a fluidized bed (i.e. electrostatic powder-coating and then melting of the powder of the mixture of polymer and ferrimagnetic or ferromagnetic particles in a stove heated to a temperature above the melting point of the polymer), either by powder-coating and then melt-cladding, and then production of the composite from the prepregs, or by filament winding (winding of the bundles of fibers on a mandrel), for making hollow bodies for example, or by pressing and thermoforming of plates made from the prepreg fiber mats, for making shells.
Finally for the bundles of fibers, production of the composite by pultrusion for making profiles (drawing of bundles of fibers and continuous impregnation of the mixture of molten polymer and ferrimagnetic or ferromagnetic particles or in a fluidized bed and passage through a heating jig giving the shape of the profile section).

The device enabling welding to be carried out by electromagnetic induction is a generator of alternating electromagnetic fields providing a frequency between 50 KHz and 100 MHz, and preferably between 100 KHz and 10 MHz.

### EXAMPLES

### Example 1

A laboratory co-rotating twin-screw extruder of type THERMO RHEO with screw diameter of 16 mm and length of 25*D operating with a flat temperature profile at 380° C. with a flow rate of 0.5 kg/h and a rotary speed of 200 rpm is fed with 60 wt. % of PEKK and 40 wt. % of iron powder ASC 200 supplied by the company Höganas. The extruded rod thus obtained is cooled and granulated.

The granules are molded at 370° C. then the plates are cut into strips of 10×5×1 mm³. Samples of pure PEKK with the same dimensions are also prepared.

In parallel, granules of PEKK alone are injection-molded in the form of dumb-bells ISO 527 1 BA. The main injection conditions are as follows: Injection. temperature: 370° C.

Mold temperature: 200° C.

These ISO 527 1BA tensile test specimens are cut in two in the central region. The 10×5×1 mm³ strips are placed between the two parts of the cut test specimen, a pressure is applied from above, compressing the two parts of the dumb-bells. An electromagnetic field of 1.5 MHz is applied using a Sinus 102-2 10 kW generator from the company Himmelwerk. The power is set to 100% of maximum power. The field is applied for a time varying between 15 seconds and 5 minutes.

After the test, the two half-specimens on either side of the strip of PEKK alone are still separate. The two half-specimens on either side of the strip composed of PEKK and ferrimagnetic particles are bonded together. One end is suspended in the jaw of a tensile tester, a free jaw is clamped to the other end, the two parts of the test specimen remain bonded and do not come apart, proving that welding has certainly taken place.

### Example 2

A similar test is performed, replacing the ASC 200 powder with Electronic Oxide 40 powder supplied by the company Höganas.

The same tests are performed and equally good adhesion of the two ends of the test specimen is obtained, but with a much shorter time of application of the electromagnetic field.

1. A composition comprising: a combination of:
at least one polymer comprising at least one polyarylene ether ketone, and optionally, comprising at least one reinforcing filler, and
at least one ferromagnetic or ferrimagnetic conductive particle.

2. The composition as claimed in claim 1, wherein the ferromagnetic or ferrimagnetic conductive particle is selected from iron compounds, or alloys based on iron and one or more elements selected from the group consisting of manganese, cobalt, magnesium, copper, nickel, and oxygen.

3. The composition as claimed in claim 1, wherein the ferromagnetic or ferrimagnetic conductive particle has an average diameter between 1 μm and 1 mm.

4. The composition as claimed in claim 1, wherein the ferromagnetic or ferrimagnetic conductive particle possesses an electrical conductivity greater than 10⁻³ S measured according to standard ASTM D 4496.

5. The composition as claimed in claim 1, wherein the ferromagnetic or ferrimagnetic conductive particle represents 5 to 80 wt. % of the weight of the composition.

6. The composition as claimed in claim 1, wherein the reinforcing filler is selected from the group consisting of talc, montmorillonite, chalk, mica, and kaolin.

7. The composition as claimed in claim 1, wherein the reinforcing filler is present in proportions in the range from 5 to 30 wt. % of the composition.

8. The composition as claimed in claim 1, wherein the reinforcing filler is selected from glass fiber or carbon fiber.

9. The composition as claimed in claim 8, wherein the fibers are in the form of woven or nonwoven mats.

10. The composition as claimed in claim 1, wherein the reinforcing filler is selected from the group consisting of expanded or unexpanded graphite, carbon black, and carbon nanotubes.

11. The composition as claimed in claim 8, wherein the reinforcing filler is present in proportions from 5 to 60 wt. % of the composition.

12. The composition as claimed in claim 1, wherein the polyarylene ether ketone is selected from the group consisting of PEKK, PEEK, PEK, PEEKK, PEKEKK, and a mixture thereof.

13. The composition as claimed in claim 1, wherein the polyarylene ether ketone is PEKK.

14. The composition as claimed in claim 1, wherein the polymer is present in proportions in the range from 1 to 99 wt. % of the weight of the composition.

15. A method comprising using the composition as claimed in claim 1 for making objects that are welded by electromagnetic induction.

16. An object which has been made from the composition as claimed in claim 1.

17. A method of induction welding comprising employing at least two objects as claimed in claim 16 and using an alternating electromagnetic field with a frequency between 50 KHz and 100 MHz.
